(19) United States
(12) Patent Application Publication
(10) Pub. No.: US 2025/0370091 A1
(43) Pub. Date: Dec. 4, 2025

(54) RADAR APPARATUS AND VEHICLE CONTROL SYSTEM

(71) Applicant: HL Klemove Corp., Incheon (KR)

(72) Inventors: Kyung-Jin YOU, Incheon (KR); Jae Hyun HAN, Incheon (KR); Han Byul LEE, Incheon (KR)

(73) Assignee: HL Klemove Corp., Incheon (KR)

(21) Appl. No.: 18/894,463

(22) Filed: Sep. 24, 2024

(30) Foreign Application Priority Data
May 29, 2024 (KR) 10-2024-0070362

(51) Int. Cl. G01S 7/03; G01S 13/931

(52) U.S. Cl. CPC G01S 7/032; G01S 13/931

(57) ABSTRACT

An antenna arrangement of a radar apparatus. A signal processor controls transmission and reception of radar signals through transmitting channels and receiving channels, and processes the radar signals. A transmitter includes a plurality of transmitting antennas connected to the transmitting channels, respectively, and spaced apart from each other according to a predetermined transmitting antenna spacing factor and a unit separation distance. A receiver includes a plurality of receiving antennas connected to the receiving channels, respectively, and spaced apart from each other according to a predetermined receiving antenna spacing factor and the unit separation distance. The transmitter includes first to fourth transmitting antennas arranged sequentially. The receiver includes first to fourth receiving antennas arranged sequentially. A total arrangement distance for the first to fourth transmitting antennas and a total arrangement distance for the first to fourth receiving antennas are equal.

### CROSS REFERENCE TO RELATED APPLICATION

This application claims priority from Korean Patent Application No. 10-2024-0070362, filed on May 29, 2024, which is hereby incorporated by reference for all purposes as if fully set forth herein.

### BACKGROUND

### Field

Embodiments relate to an antenna arrangement of a radar apparatus and a vehicle control system including the radar apparatus.

### Description of Related Art

Recently, consumers have become increasingly concerned about the performance and safety of their vehicles. As demand for vehicle performance, driver comfort, and safety has increased, research and development of advanced driver assistance systems (ADAS) controlling a vehicle and assist a driver in driving the vehicle has continued. Such advanced driver assistance systems refer to a variety of systems that minimize or prevent damage from vehicle accidents by enabling drivers to take appropriate actions based on external environmental information detected by vehicle sensors and cameras, or by automatically controlling vehicles to create a safer driving environment.

In addition, automotive radar apparatuses are used in driver assistance systems or autonomous driving systems to measure the distances, relative speeds, and heading angles of other vehicles and stationary targets by monitoring the environment. Specifically, the radar apparatus detects the azimuth of an object, i.e., the angle between the line of sight to the object in a horizontal plane and the forward direction of the vehicle, to determine whether driving is possible or whether the object is an actual obstacle. Accordingly, the radar apparatus may be configured with a structure in which a plurality of physically separate receiving antennas are arrayed for the radar sensor to have a high angular resolution characteristic. However, a radar apparatus having such an array structure suffers from the problem that the antenna size thereof may be increased, and a transmitter and a receiver require a large number of related elements, thereby resulting in a large overall size. In particular, a radar apparatus for a vehicle has a problem that the size of the radar apparatus is limited, since the portions in which the radar apparatus may be mounted are limited by various structures such as license plates, fog lights, support structures, and the like.

In this situation, there is need for a radar apparatus able to achieve a high resolution using a multifunctional monolithic microwave integrated circuit (MMIC) while being miniaturizable.

### BRIEF SUMMARY

Embodiments may provide a radar apparatus having a high resolution.

According to one aspect, embodiments may provide a radar apparatus including: a signal processor controlling transmission and reception of radar signals through transmitting channels and receiving channels, and processing the radar signals; a transmitter including a plurality of transmitting antennas connected to the transmitting channels, respectively, and spaced apart from each other according to a predetermined transmitting antenna spacing factor and a unit separation distance; and a receiver including a plurality of receiving antennas connected to the receiving channels, respectively, and spaced apart from each other according to a predetermined receiving antenna spacing factor and the unit separation distance, wherein the transmitter includes first to fourth transmitting antennas arranged sequentially, and the receiver includes first to fourth receiving antennas arranged sequentially, and a total arrangement distance for the first to fourth transmitting antennas and a total arrangement distance for the first to fourth receiving antennas are set to be equal.

According to another aspect, embodiments may provide a radar apparatus including: a signal processor controlling transmission and reception of radar signals through transmitting channels and receiving channels, and processing the radar signals; a transmitter including a plurality of transmitting antennas connected to the transmitting channels, respectively, and spaced apart from each other according to a predetermined transmitting antenna spacing factor and a unit separation distance; and a receiver including a plurality of receiving antennas connected to the receiving channels, respectively, and spaced apart from each other according to a predetermined receiving antenna spacing factor and the unit separation distance, wherein the transmitter includes first to fourth transmitting antennas arranged sequentially in a first direction, and the receiver includes first to fourth receiving antennas arranged sequentially in the first direction, a total arrangement distance for the first to fourth transmitting antennas in the first direction and a total arrangement distance for the first to fourth receiving antennas in the first direction are set to be equal, and at least one of the first to fourth transmitting antennas and the first to fourth receiving antennas is spaced apart in a second direction.

According to another aspect, embodiments may provide a vehicle control system including a radar apparatus, the vehicle control system including: a radar apparatus controlling transmission and reception of radar signals through transmitting channels and receiving channels and processing the radar signals, wherein the radar apparatus includes: a plurality of transmitting antennas connected to the transmitting channels, respectively, and spaced apart from each other according to a predetermined transmitting antenna spacing factor and a unit separation distance;

a plurality of receiving antennas connected to the receiving channels, respectively, and spaced apart from each other according to a predetermined receiving antenna spacing factor and the unit separation distance, wherein the transmitter includes first to fourth transmitting antennas arranged sequentially, the receiver includes first to fourth receiving antennas arranged sequentially, and a total arrangement distance for the first to fourth transmitting antennas and a total arrangement distance for the first to fourth receiving antennas are set to be equal; and a controller generating control signals based on vehicle's surrounding object information detected using the radar signals received from the radar apparatus.

According to embodiments, the radar apparatus having a high resolution and the vehicle control system including the same may be provided.

### DESCRIPTION OF DRAWINGS

The above and other objects, features, and advantages of the present disclosure will be more clearly understood from the following detailed description, taken in conjunction with the accompanying drawings, in which:

FIG. 1 is a block diagram illustrating the configuration of a radar apparatus according to embodiments;

FIG. 2 is a diagram illustrating an implementation of the configuration of the radar apparatus according to embodiments;

FIG. 3 is a diagram illustrating the respective separation distances of the transmitting antennas and the receiving antennas according to embodiments;

FIG. 4 is a diagram illustrating the transmitting antenna spacing factor and the receiving antenna spacing factor according to embodiments;

FIG. 5 is a diagram illustrating an example arrangement of the transmitting antennas and the receiving antennas according to embodiments;

FIG. 6 is a diagram illustrating another example arrangement of the transmitting antennas and the receiving antennas according to embodiments;

FIG. 7 is a diagram illustrating an example of the transmitting antennas and the receiving antennas arranged on a single straight line according to embodiments;

FIG. 8 is a diagram illustrating the creation of virtual channels according to embodiments;

FIG. 9 is a diagram illustrating the operation of creasing a ULA using DCAs according to embodiments;

FIG. 10 is a diagram illustrating an angle power spectrum of the radar apparatus according to embodiments; and

FIG. 11 is a diagram illustrating an example of an arrangement spaced in a second direction according to embodiments.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after”, “subsequent to”, “next”, “before”, and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

As used herein, the terms “first direction” and “second direction” may be perpendicular to each other. For example, if the “second direction” is a direction perpendicular to the ground, the “first direction” may be a direction horizontal to the ground perpendicular to the second direction. Otherwise, if the “second direction” is a vertical direction, the “first direction” may be a horizontal direction perpendicular to the second direction.

In addition, as used herein, the terms “transmitting antenna” and “receiving antenna” refer to antennas for radiating radar signals and receiving reflected radar signals. For example, each of the antennas may be an antenna including one or more patch antennas. Otherwise, the antenna may be a micro-strip patch antenna. Otherwise, the antenna may be a waveguide antenna. However, the type of the antenna is not limited as long as the antennas may radiate radar signals and receive reflected radar signals.

Radar apparatuses are used in a wide range of applications. Radar apparatuses ae used in a variety of fields from high-power and high-resolution military radar apparatuses to vehicle-mounted radars that are actively in use.

Because radar apparatuses are used in a variety of applications, the requirements for respective applications may vary. For example, radar apparatuses used in military applications are required to have a high angular resolution, and therefore includes hundreds of receiver channels. This is because a ship or a ground radar station that operates the radar apparatus may provide a large space and high power.

In contrast, small radar apparatuses, such as automotive radar apparatuses, are required to have high resolution but the volumes thereof are severely limited. Therefore, there is demand for a radar apparatus able to provide an ideal high resolution while maintaining a small size.

As such, in order for a radar apparatus to have high angular resolution characteristics, physically separate receiving antennas must have a large number of channels. As an extreme example as stated above, military radars respectively include hundreds of receiver channels. However, for economic reasons and space limitations, the number of receiver channels in an automotive radar apparatus is limited.

In addition, in recent years, a single integrated circuit (MMIC) including a transmitter and a receiver is generally used, and therefore the number of channels is generally determined by the number of MMICs of the system.

Therefore, an efficient antenna arrangement is required even in a case in which a single MMIC having a limited number of receiver channels and a limited number of transmitter channels is used. Here, the term “efficient” means that the spacing of a virtual antenna arrangement resulting from the arrangement of transmitting and receiving antennas is as close to half the wavelength and as uniform as possible. A straight-line arrangement in which all arrangement spacings are uniformly half a wavelength is referred to as a uniform linear antenna (ULA).

However, the area required to physically construct a real ULA may increase dramatically. Therefore, the present disclosure is intended to describe a technology enabling an antenna arrangement having a high angular resolution even for a limited number of channels, such as in a single MMIC.

Hereinafter, a case in which there are four transmitting channels and four receiving channels is described for ease of understanding. However, this embodiment may also be applied to a case in which there are a plurality of transmitting channels and a plurality of receiving channels, and the number of channels is not limited to four.

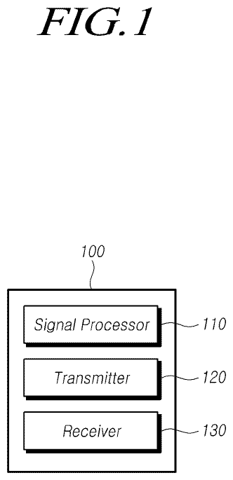

FIG. 1 is a block diagram illustrating the configuration of a radar apparatus according to embodiments.

Referring to FIG. 1, a radar apparatus 100 includes: a signal processor 110 controlling the transmission and reception of radar signals through transmitting channels and receiving channels and processing the radar signals; a transmitter 120 including a plurality of transmitting antennas connected to the transmitting channels, respectively, and spaced apart from each other according to a predetermined transmitting antenna spacing factor and a unit separation distance; and a receiver 130 including a plurality of receiving antennas connected to the receiving channels, respectively, and spaced apart from each other according to a predetermined receiving antenna spacing factor and a unit separation distance.

For example, the signal processor 110 may control the operation of receiving radar signals radiated through the transmitting antennas and radar signals reflected by objects. The signal processor 110 may process the radar signals by creating 16 virtual channels using the radar signals and creating 48 difference co-arrays (DCAs) using the 16 virtual channels.

In addition, the signal processor 110 may process the radar signals by removing one DCA having a non-uniform DCA spacing from the 48 DCAs and creating a uniform linear array (ULA) using the 47 DCAs. As a result, the radar signal processing operation having high resolution may be performed.

The radar apparatus may include the transmitter 120 including the transmitting antennas and the receiver 130 including the receiving antennas. There are no restrictions on the types of antennas included in the transmitter 120 or the receiver 130. Each of the transmitting antennas is connected to the corresponding transmitting channel of the signal processor 110, and each of the receiving antennas is connected to the corresponding receiving channel of the signal processor 110.

For example, the transmitter 120 includes first to fourth transmitting antennas arranged sequentially. The receiver 130 includes first to fourth receiving antennas arranged sequentially.

The four transmitting antennas are arranged to maintain uniform spacings from each other. The four receiving antennas are also arranged to maintain uniform spacings from each other. For example, a total arrangement distance for the first to fourth transmitting antennas and the total arrangement distance for the first to fourth receiving antennas may be set to be the same. In addition, the transmitting antenna spacing factor and the receiving antenna spacing factor may be set differently.

Here, the separation distance between the respective transmitting antennas may be determined using the transmitting antenna spacing factor and the unit separation distance. Similarly, the separation distance between the respective receiving antennas may be determined using the receiving antenna spacing factor and the unit separation distance.

For example, the four transmitting antennas are spaced apart from each other according to the product of the predetermined transmitting antenna spacing factor and the unit separation distance. The four receiving antennas are spaced apart from each other according to the product of the predetermined receiving antenna spacing factor and the unit separation distance. Therefore, each of the four transmitting antennas and the four receiving antennas has a spacing factor of three (3).

In one example, the predetermined transmitting antenna spacing factor includes a first factor set between the first transmitting antenna and the second transmitting antenna, a second factor set between the second transmitting antenna and the third transmitting antenna, and a third factor set between the third transmitting antenna and the fourth transmitting antenna.

In addition, the predetermined receiving antenna spacing factor may include a fourth factor set between the first receiving antenna and the second receiving antenna, a fifth factor set between the second receiving antenna and the third receiving antenna, and a sixth factor set between the third receiving antenna and the fourth receiving antenna.

As described above, the first to sixth factors may be set to different values.

On the other hand, the sum of the first to third factors may be set equal to be the sum of the fourth to sixth factors. For example, if the sum of the first to third factor is set to 24, the sum of the fourth to sixth factors may also be set to be 24.

In one example, if the sum of the first to third factors or the sum of the fourth to sixth factors is set to be 24, the second factor or the fifth factor may be set to be 19.

In another example, if each of the sum of the first to third factors and the sum of the fourth to sixth factors is set to be 24, the second factor may be set to be 12 and the fifth factor may be set to be 19.

In another example, if each of the sum of the first to third factors and the sum of the fourth to sixth factors is set to be 24, the second factor may be set to be 19 and the fifth factor may be set to be 12.

On the other hand, if the second factor is set to be 19, the first factor or the third factor may be set to be any value of 2 or 3. In this case, the first factor and the sixth factor are set to be different values, such that if the first factor is set to be 2, the third factor can be set to be 3. The reverse is also possible.

In another example, if the fifth factor is set to be 19, the fourth factor or the sixth factor may be set to be any value of 2 or 3. In this case, the first factor and the sixth factor are set to be different values, such that if the fourth factor is set to be 2, the sixth factor may be set to be 3. The reverse is also possible.

Since the second factor or the fifth factor may be set to be 12 or 19 for a total of 24, a case in which the second factor or the fifth factor is 12 is also be described.

If the second factor is set to be 12, the first factor or the third factor may be set to be any value of 4 or 8. In this case, the first factor and the sixth factor are set to be different values, such that if the first factor is set to be 4, the third factor may be set to be 8. The reverse is also possible.

If the fifth factor is set to be 12, the fourth factor or the sixth factor may be set to be any value of 4 or 8. In this case, the fourth factor and the sixth factor are set to be different values, such that if the fourth factor is set to be 4, the sixth factor can be set to be 8. The reverse is also possible.

The factor settings described above may be summarized, for example, as follows.

For example, the first factor may be set to be 4, the second factor may be set to be 12, and the third factor may be set to be 8. Because the unit separation distances are the same value, 4, 12, and 8 have no unit, and may be understood as ratios.

In another example, the first factor may be set to be 8, the second factor may be set to be 12, and the third factor may be set to be 4. Otherwise, the first factor may be set to be 2, the second factor may be set to be 19, and the third factor may be set to be 3. Otherwise, the first factor may be set to be 3, the second factor may be set to be 19, and the third factor may be set to be 2.

In summary, the transmitting antenna spacing factor may be determined as one of {4, 12, 8}, {8, 12, 4}, {2, 19, 3}, or {3, 19, 2}. This is a result of the symmetry of {4, 12, 8} and the change in relation to the receiving antenna spacing factor. However, the transmitting antenna spacing factor may be paired with the receiving antenna spacing factor.

In the receiving antenna spacing factor, the fourth factor may be set to be 2, the fifth factor may be set to be 19, and the sixth factor may be set to be 3. Otherwise, the fourth factor may be set to be 3, the fifth factor may be set to be 19, and the sixth factor may be set to be 2. Otherwise, the fourth factor may be set to be 4, the fifth factor may be set to be 12, and the sixth factor could be set to be 8. Otherwise, the fourth factor may be set to be 8, the fifth factor could be set to be 12, and the sixth factor may be set to be 4.

In summary, the receiving antenna spacing factor may be determined as one of {2, 19, 3}, {3, 19, 2}, {4, 12, 8}, or {8, 12, 4}. This is a result of the symmetry of {2, 12, 3} and the change in relation to the transmitting antenna spacing factor. However, the receiving antenna spacing factor may be paired with the transmitting antenna spacing factor.

Since the case of exchanging the transmitting antenna spacing factor and the receiving antenna spacing factor has been described above, a total of eight pairs of transmitting antenna spacing factor and receiving antenna spacing factor may be set. The eight pairs are shown below. T is the transmitting antenna spacing factor, and R is the receiving antenna spacing factor.
T={4, 12, 8}, R={2, 19, 3}
T={8, 12, 4}, R={2, 19, 3}
T={8, 12, 4}, R={3, 19, 2}
T={4, 12, 8}, R={3, 19, 2}
T={2, 19, 3}, R={4, 12, 8}
T={2, 19, 3}, R={8, 12, 4}
T={3, 19, 2}, R={8, 12, 4}
T={3, 19, 2}, R={4, 12, 8}

As described above, the transmitting antenna spacing factor and the receiving antenna spacing factor are values intended to represent the spacing of the transmitting antennas and the receiving antennas, respectively. Thus, the transmitting antenna spacing factor and the receiving antenna spacing factor have no unit, and may be understood as ratios.

The separation distance between the respective antennas may be determined to be the product of the transmitting antenna spacing factor and the unit separation distance. For example, the unit separation distance may vary depending on the frequency of the radar signals. In one example, the unit separation distance may be set to be half the wavelength of the frequency of the radar signals. In another example, the unit separation distance may be set to be an arbitrary number, such as 1.1. Thus, the unit separation distance may be determined by the size of the radar apparatus. In another example, the unit separation distance may be fixed to half the wavelength of the frequency, and the spacing factor may be multiplied by an integer. This is because the spacing factor is to be understood as a ratio, so that multiplying with an integer does not change the ratio of the spacing factor.

On the other hand, the transmitting antenna spacing factor, the receiving antenna spacing factor, and the unit separation distance only indicate the separation distance between the respective antennas, but do not indicate the positions in two-dimensional space. That is, the separation distance between the antennas only indicates the separation distance in the first direction.

For example, the four transmitting antennas and the four receiving antennas may be arranged on respective straight lines to be spaced apart from each other. That is, the four transmitting antennas may be spaced apart from each other on a single straight line. In this case, the separation in the second direction is not taken into account. In the same manner, the four receiving antennas may be spaced apart from each other on a single straight line.

In one example, the straight line on which the four transmitting antennas are arranged to be spaced apart from each other may be configured to be parallel to the straight line on which the four receiving antennas are arranged to be spaced apart from each other.

In another example, the four transmitting antennas and the four receiving antennas may be spaced apart from each other on the same straight line. In this case, the separation distance between the respective transmitting antennas (or the respective receiving antennas) is determined by the spacing factor and the unit separation distance described above. In this case, there is no limit to the separation distance between the transmitting antenna and the receiving antenna.

On the other hand, the separation distance between the antennas only indicates the separation distance in the first direction. Therefore, the position in the second direction should also be considered for the arrangement of the antennas. The following shows an embodiment of the position regarding the second direction.

The radar apparatus 100 may include the signal processor 110 controlling the transmission and reception of radar signals through the transmitting channels and the receiving channels and processes the radar signals. The radar apparatus 100 may include the transmitter 120 including the plurality of transmitting antennas connected to the transmitting channels, respectively, and spaced apart from each other according to the predetermined transmitting antenna spacing factor and the unit separation distance. The radar apparatus 100 may include the receiver 130 including the plurality of receiving antennas connected to the receiving channels, respectively, and spaced apart from each other according to the predetermined receiving antenna spacing factor and the unit separation distance.

Here, the transmitter 120 includes the first to fourth transmitting antennas arranged sequentially in the first direction. The receiver 130 includes the first to fourth receiving antennas arranged sequentially in the first direction.

The total arrangement distance for the first to fourth transmitting antennas in the first direction and the total arrangement distance for the first to fourth receiving antennas in the first direction may be set to be the same.

In addition, at least one of the first to fourth transmitting antennas and the first to fourth receiving antennas may be spaced apart in the second direction.

For example, the four transmitting antennas and the four receiving antennas may be arranged on respective straight lines to be spaced apart from each other. In this case, at least one transmitting antenna or receiving antenna may be spaced apart in the second direction. The arrangement spacing taking into account the spacing factor and the unit separation distance may be in the first direction, and even in the case in which the separation is in the second direction, the arrangement spacing in the first direction may be set as described above.

In a case in which the arrangement features described above are represented, the signal processor 110 having four transmitting channels and four receiving channels may create 16 virtual channels to create 48 DCAs. In addition, the signal processor 110 may remove one DCA having a non-uniform spacing from the 48 DCAs and create a ULA having 47 DCAs. For example, the signal processor 110 may remove the last DCA, which has a different spacing, from the DCAs, such that only 47 DCAs having equal spacings may be selected and created as a ULA.

Accordingly, a radar apparatus having a high resolution depending on the ULA may be provided.

The arrangement structures of the transmitting antennas and the receiving antennas of the radar apparatus having a high angular resolution has been described above.

Reference is made below to the drawings to more visually illustrate the arrangement structures described above. However, this is for ease of understanding only and it will be apparent that an arrangement structure not shown below may be implemented by any combination of the various embodiments described above. Accordingly, any combination of the various embodiments described above should be included in the embodiments of the present disclosure.

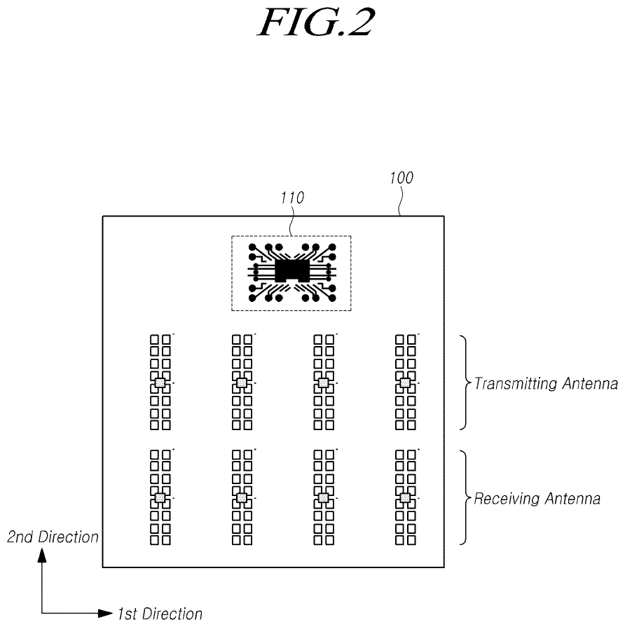

FIG. 2 is a diagram illustrating an implementation of the configuration of the radar apparatus according to embodiments.

Referring to FIG. 2, the radar apparatus 100 may include the signal processor 110, the transmitting antennas, and the receiving antennas. For example, the transmitting antennas may be patch array antennas. The receiving antennas may also be patch array antennas.

The signal processor 110 may be implemented as a monolithic microwave integrated circuit (MMIC). The MMIC is a single integrated IC, and may include four transmitting channels and four receiving channels. Each of the four transmitting channels may be connected through four transmitting antennas and a feed line. Each of the four receiving channels may also be connected through four receiving antennas and a feed line.

A single radar apparatus 100 may be integrated and packaged on a substrate or the like. The transmitting antenna and the receiving antenna are shown here as being arranged in the second direction as an example, but are not limited thereto.

In the following, the position of each of the transmitting antennas and the receiving antennas is shown and described as a single location point (i.e., a reference point). In the case of a patch array antenna as shown in FIG. 2, the location point may be set at the center of each antenna, but is not limited thereto. The location point may be set in various manners depending on the type and shape of each antenna, the number of arrays, and the like.

In the present disclosure, the design of the arrangement is mainly described in terms of the separation distance between the antennas, but the setting of the location points may be varied.

In a case in which the spacings between the centers of the respective virtual antenna channels are equal to the length of half the wavelength, the shape of a beam pattern produced by the virtual antenna channels together is ideal. If the spacing is greater than half the wavelength, a grating lobe is created in the beam pattern of the virtual antennas, and the antennas may not be considered to be sensitive to only one direction. Consequently, the ambiguity in estimating the azimuth of the target increases. However, in a case in which the receiving antennas are arranged such that the spacing is less than half the wavelength apart, the size of the virtual antenna aperture may not be large enough. The size of the aperture is inversely proportional to the angular resolution. In addition, in a case in which the antennas are arranged such that the spacing is equal to the maximum distance between the transmitting antennas, the virtual antenna aperture may be large enough, but the radar itself may be overly oversized.

In the following, an embodiment of the antenna arrangement able to solve the problems described above and form an ideal virtual antenna channel having a high resolution is described. There are four transmitting antennas and four receiving antennas. The positions of the transmitting antennas are indicated by circles, and the positions of the receiving antennas are indicated by squares.

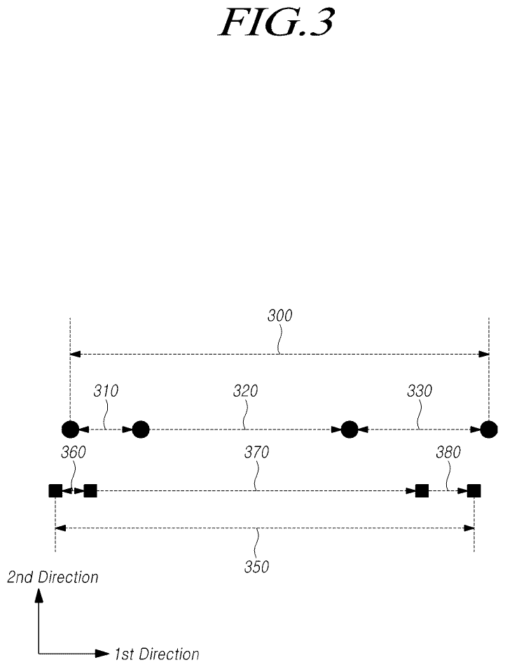

FIG. 3 is a diagram illustrating the respective separation distances of the transmitting antennas and the receiving antennas according to embodiments.

Referring to FIG. 3, the positions of the transmitting antennas (i.e., circles) are set to form separation distances 310, 320, and 330 between the respective transmitting antennas, and the positions of the receiving antennas (i.e., squares) are set to form separation distances 360, 370, and 380 between the respective receiving antennas.

The total arrangement distance 300 of the transmitting antennas indicates the separation distance between the arrangement position of the first transmitting antenna and the arrangement position of the last transmitting antenna. The total arrangement distance of the receiving antennas 350 also indicates the separation distance between the arrangement position of the first receiving antenna and the arrangement position of the last receiving antenna.

For example, the separation distances 310, 320, and 330 between the respective transmitting antennas are determined based on a predetermined transmitting antenna spacing factor and a unit separation distance. Similarly, the separation distances 360, 370, and 380 between the respective receiving antennas are determined based on a predetermined receiving antenna spacing factor and the unit separation distance.

In the radar apparatus according to one embodiment, the total arrangement distance 300 of the transmitting antennas is set to be the same as the total arrangement distance 350 of the receiving antennas. That is, even in the case in which the respective transmitting antennas and the respective receiving antenna are arrangement at different positions, the total arrangement distance 300 of the transmitting antennas and the total arrangement distance 350 of the receiving antennas are the same. For example, each of the total arrangement distance 300 of the transmitting antennas and the total arrangement distance 350 of the receiving antennas is determined to be 24 multiplied by the unit separation distance. However, the spacings 310, 320, 330, 360, 370, and 380 between the four transmitting antennas and the four receiving antennas are set different.

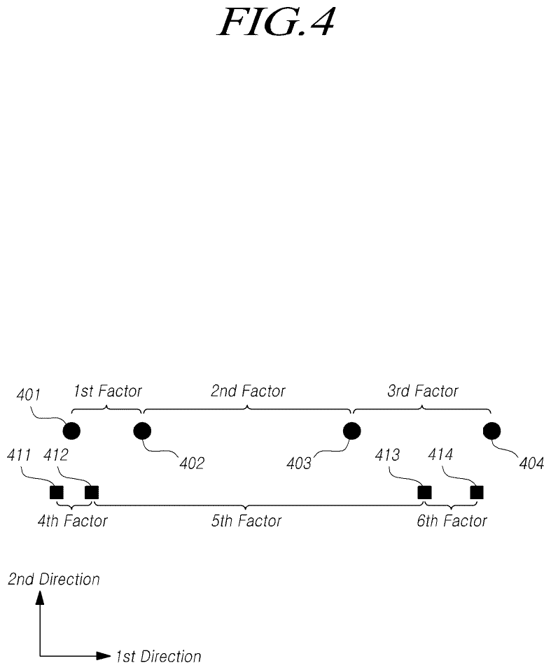

FIG. 4 is a diagram illustrating the transmitting antenna spacing factor and the receiving antenna spacing factor according to embodiments.

Referring to FIG. 4, the four transmitting antennas 401 to 404 are spaced apart from each other according to the product of a predetermined transmitting antenna spacing factor and a unit separation distance. The four receiving antennas 411 to 414 are spaced apart from each other according to the product of a predetermined receiving antenna spacing factor and a unit separation distance.

The predetermined transmitting antenna spacing factor includes a first factor set between the first transmitting antenna 401 and the second transmitting antenna 402, a second factor set between the second transmitting antenna 402 and the third transmitting antenna 403, and a third factor set between the third transmitting antenna 403 and the fourth transmitting antenna 404.

In the same manner, the predetermined receiving antenna spacing factor includes a fourth factor set between the first receiving antenna 411 and the second receiving antenna 412, a fifth factor set between the second receiving antenna 412 and the third receiving antenna 413, and a sixth factor set between the third receiving antenna 413 and the fourth receiving antenna 414.

As described with reference to FIG. 3, each of the total arrangement distance 300 of the transmitting antennas and the total arrangement distance 350 of the receiving antennas is determined to be the unit separation distance multiplied by 24. Accordingly, the sum of the first factor, the second factor, and the third factor is set to be 24. The sum of the fourth factor, the fifth factor, and the sixth factor is also set to be 24.

That is, the total of the predetermined spacing factors of the transmitting antennas and the total of the predetermined spacing factors of the receiving antennas are set to be the same. For example, each of the totals is set to be 24.

The predetermined transmitting antenna spacing factor and the predetermined receiving antenna spacing factor are both factors for determining the spacing between antennas in the first direction. Therefore, the transmitting antenna spacing factor and the receiving antenna spacing factor are independent of the separation distance in the second direction.

On the other hand, the unit separation distance may be determined in relation to the frequency of the radar signals. For example, the unit separation distance may be set to be half the wavelength of the frequency of the radar signals. In one example, the unit separation distance may be determined to be 2.5 mm if the frequency of the radar signals is 60 GHz, or 1.875 mm if the frequency is 80 GHz. In another example, the unit separation distance may be determined to be an arbitrary number. The arbitrary number may be an experimental value that is determined to be optimal by, for example, experimentation. For example, the unit separation distance may be set to be a constant number, such as 1.1.

In the following, an example of the predetermined transmitting antenna spacing factor and the predetermined receiving antenna spacing factor is described.

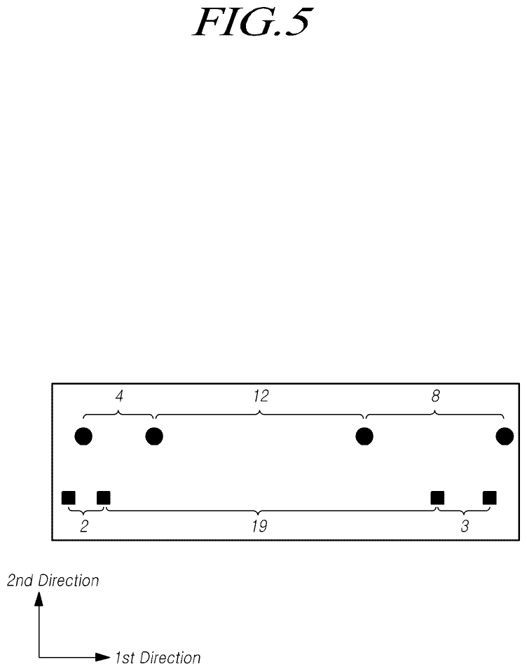

FIG. 5 is a diagram illustrating an example arrangement of the transmitting antennas and the receiving antennas according to embodiments.

Referring to FIG. 5, the first factor may be set to be 4, the second factor may be set to be 12, and the third factor may be set to be 8. In addition, the fourth factor may be set to be 2, the fifth factor may be set to be 19, and the sixth factor may be set to be 3. That is, the set of factors may be represented as T={4, 12, 8} and R={2, 19, 3}.

The transmitting antennas are shown as being located above the receiving antennas, but the embodiments are not limited to such a correlation. The second direction is irrelevant, and only the separation distance between the respective transmitting antennas and only the separation distance between the respective receiving antennas in the first direction is a significant factor.

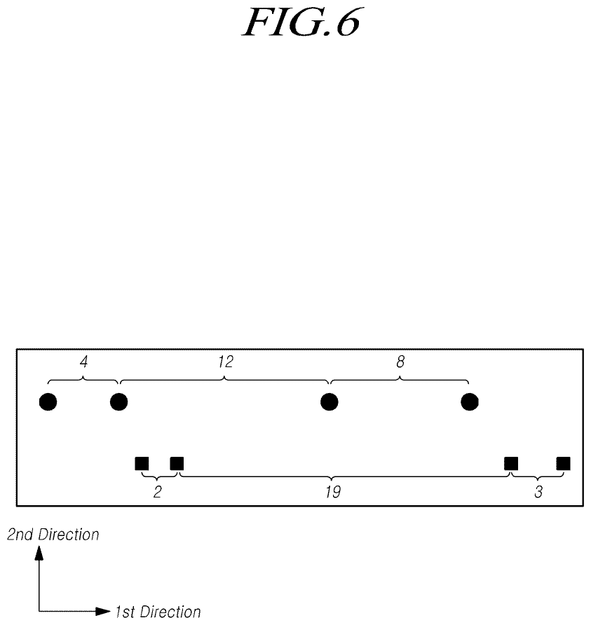

FIG. 6 is a diagram illustrating another example arrangement of the transmitting antennas and the receiving antennas according to embodiments.

Referring to FIG. 6, an arrangement in which the receiving antennas of FIG. 5 are shifted as a whole in the first direction is shown. If the total arrangement length of the transmitting antennas and the total arrangement length of the receiving antennas are the same, and the spacing factors of the transmitting antennas and the receiving antennas are set to be T={4, 12, 8} and R={2, 19, 3}, the arrangement position of the receiving antennas may be set variously. That is, the spectra of FIG. 5 and FIG. 6 show the same characteristics.

Here, the four transmitting antennas and the four receiving antennas may be arranged on respective straight lines to be spaced apart from each other. That is, as shown in FIG. 6, the transmitting antennas may be arranged on the straight line in the first direction. In the same manner, the receiving antennas may also be arranged on the straight line in the first direction. For example, the straight line on which the four transmitting antennas are arranged to be spaced apart may be set parallel to the straight line on which the four receiving antennas are arranged to be spaced apart.

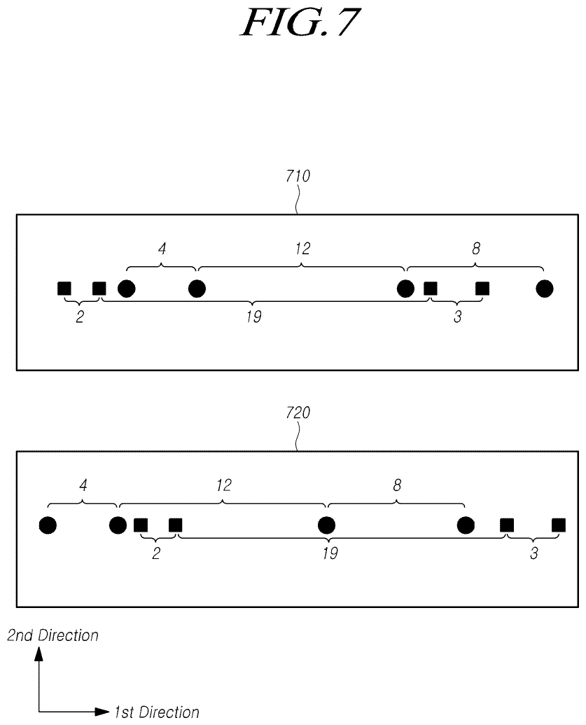

FIG. 7 is a diagram illustrating an example of the transmitting antennas and the receiving antennas arranged on a single straight line according to embodiments.

Referring to FIG. 7, the four transmitting antennas and the four receiving antennas may be arranged a single straight line to be spaced apart from each other. In contrast to FIG. 6, all of the transmitting antennas and the receiving antennas are arranged the single straight line to be spaced apart from each other.

In this case, the separation distances between the transmitting antennas are required to satisfy the transmitting antenna spacing factor. In the same manner, the separation distances between the receiving antennas and the transmitting antennas are only required to satisfy the receiving antenna spacing factor. Therefore, the spacings between the transmitting and receiving antennas are irrelevant.

In a case in which the receiving antennas are arranged first, such as in 710 and in a case in which the transmitting antennas are arranged first, such as in 720, the same spectral characteristics are shown as in a case in which the separation distances are set as the factors T={4, 12, 8} and R={2, 19, 3}.

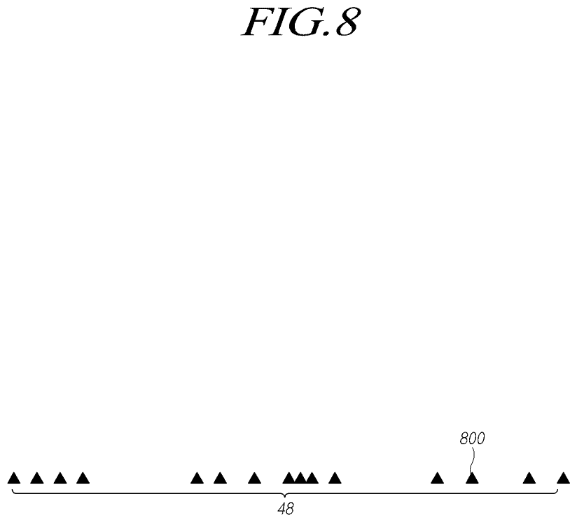

FIG. 8 is a diagram illustrating the creation of virtual channels according to embodiments.

In all of the cases of FIGS. 5 to 7, identical virtual channels 800 are created. Referring to FIG. 8, when the spacings between the respective virtual channels are marked on the same scale as in the case in which the sum of the spacing factors is 24, the spacings are represented by {2, 2, 2, 2, 10, 2, 3, 3, 1, 1, 2, 2, 9, 3, 5, 3} sequentially starting from the left channel. These spacings add up to 48. A total of 16 virtual channels 800 are created, with the eighth and ninth channels from the left having the same position, so that the diagram appears as if there are 15 channels in total. The principle of creating virtual channels is disclosed in the known art “MIMO Radar (Rev. A) (ti.com) “, and a detailed description will be omitted.

The signal processor may create 16 virtual channels and create 48 DCAs using the 16 virtual channels to process radar signals.

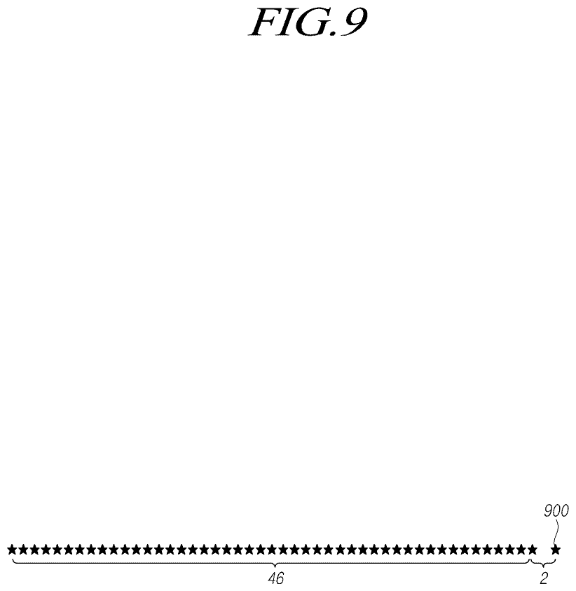

FIG. 9 is a diagram illustrating the operation of creasing a ULA using DCAs according to embodiments.

Referring to FIG. 9, the signal processor may create DCAs (having the shape of stars) again using the virtual channels 800. The principle of creating the DCAs using the virtual channels 800 is disclosed in “C.-L. Liu and P. P. Vaidyanathan, ‘Robustness of Difference Coarrays of Sparse Arrays to Sensor Failures-Part I: A Theory Motivated by Coarray MUSIC’, in IEEE Transactions on Signal Processing, vol. 67, no. 12, pp. 3213-3226, 15 Jun.15, 2019, doi: 10.1109/TSP.2019.2912882.”

The signal processor may process a radar signal by removing one DCA 900 having a non-uniform spacing from the 48 DCAs and creating a uniform linear array (ULA) from the 47 DCAs. For example, when DCAs are created using the virtual channels in FIG. 8, 47 DCAs having the same spacing are created, as shown in FIG. 9, but the spacing of the last DCA is doubled.

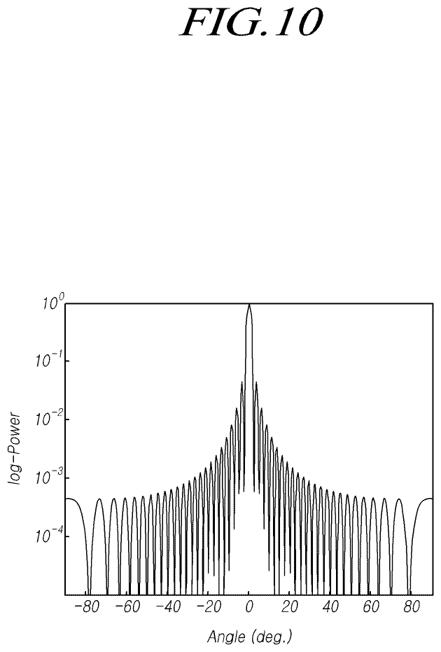

Ignoring the rightmost channel 900 in the DCA results in a contiguous array having a length of 46, in which all of channel spacings are respectively equal to 1. It is necessary to ignore the rightmost channel because the shape of a beam pattern may act unfavorable to the performance of the radar due to the empty space if the rightmost channel is not ignored. Such channels arrayed with a uniform spacing of 1 are referred to as a uniform linear array (ULA). As described above, in a case in which the unit separation distance is set as half the wavelength of frequency, a 47-channel ULA in which the spacing is half the wavelength of and the total length is 23 wavelengths may be created. The beam pattern produced by this ULA is shown in FIG. 10.

FIG. 10 is a diagram illustrating an angle power spectrum of the radar apparatus according to embodiments.

Referring to FIG. 10, in a case in which the unit separation distance is set to be half the wavelength, a ULA is created as described above. With this ULA, the beam pattern of the angle power spectrum has a high resolution of about 2.1617° for HPBW and about 2.4383° for FNBW.

Thus, in the present disclosure, in a case in which there are four transmitting channels and four receiving channels, a radar signal having an ideal beam pattern may be generated by arranging the antennas for the respective channels according to embodiments.

In addition, as described above, the separation distances of the respective transmitting antennas may be mutually symmetrical. In the same manner, the separation distances of each of the receiving antennas may be mutually symmetrical. In addition, the spacing factors of the transmitting antennas and the receiving antennas may be interchangeable. Considering all of such cases, there may be eight pairs of transmitting antenna spacing factor and receiving antenna spacing factor, as represented below. All of these are embodiments of the present disclosure.

For example, in a case in which there are four transmitting channels and four receiving channels, and the total arrangement length of the transmitting antennas and the total arrangement length of the receiving antennas are respectively equal to the unit separation distance multiplied with 24, the transmitting antenna spacing factors and the receiving antenna spacing factors may be paired as follows.
T={4, 12, 8}, R={2, 19, 3}
T={8, 12, 4}, R={2, 19, 3}
T={8, 12, 4}, R={3, 19, 2}
T={4, 12, 8}, R={3, 19, 2}
T={2, 19, 3}, R={4, 12, 8}
T={2, 19, 3}, R={8, 12, 4}
T={3, 19, 2}, R={8, 12, 4}
T={3, 19, 2}, R={4, 12, 8}

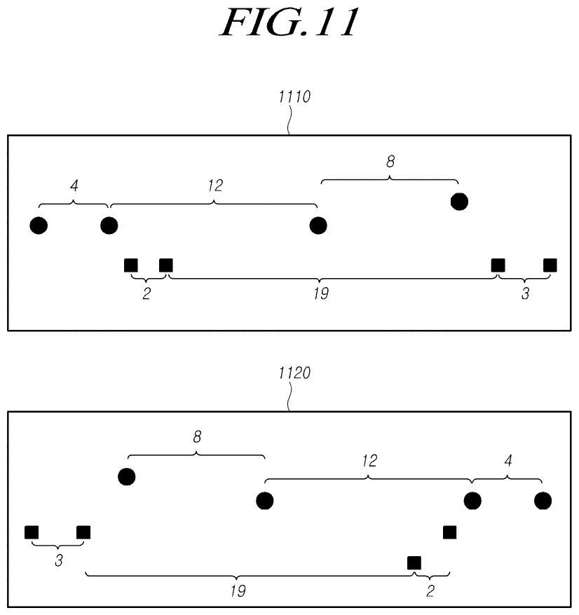

FIG. 11 is a diagram illustrating an example of an arrangement spaced in a second direction according to embodiments.

Referring to FIG. 11, the last arrangement of the transmitting antennas may not be on a straight line, as indicated by 1110. However, even in this case, the spacing factor (i.e., the third factor) between the third transmitting antenna and the fourth transmitting antenna should be determined to be 8. 1120 indicates a case in which neither the transmitting antennas nor the receiving antennas are located on a straight line in the case T={8, 12, 4} and R={3, 19, 2} described above. However, even in this case, the high-resolution beam pattern described above may be generated, since the transmitting antenna spacing factor and the receiving antenna spacing factor are arranged according to T={8, 12, 4} and R={3, 19, 2}.

As described above, by properly arranging the transmitting antennas and the receiving antennas, a 46-size ULA may be created using four transmitting channels and four receiving channels. If the unit separation distance is half the wavelength, a 47-channel virtual ULA may be created with an end-to-end spacing equal to the length of 23 wavelengths.

For example, in a case in which an arrangement structure as shown in FIG. 5 is designed on a plane by assuming a main frequency of 80 GHz, the same resolution as that of the 47-channel ULA may be obtained even in the case in which the transverse length is only 4.5 centimeters and physically eight channels are used.

Accordingly, it is possible to provide a radar apparatus that has a high resolution despite being arranged in a small space.

In addition, the radar apparatus according to the present disclosure may be mounted on a vehicle and used to detect objects in the vicinity of the vehicle.

For example, the vehicle control system may include the radar apparatus described above and a controller generating control signals based on vehicle's surrounding object information that is detected using the radar signals received from the radar apparatus.

The controller may include a chip-type circuit or semiconductor device that generates signals for vehicle control, such as an ECU or MCU.

The radar apparatus included in the vehicle control system is described with reference to FIGS. 1 to 11, and therefore is not described repeatedly.

The controller may generate vehicle control signals based on the surrounding object information detected using the radar signals received from the radar apparatus. For example, the controller may generate vehicle motion control signals to control the vehicle to avoid obstacles. In another example, the controller may generate control signals to control the operation of various devices inside the vehicle. For example, control signals may be generated for in-vehicle entertainment devices, chassis devices, acceleration and/or deceleration controllers, motion controllers, devices for providing or receiving information to or from the driver, and the like.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide one example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A radar apparatus comprising:
a signal processor controlling transmission and reception of radar signals through transmitting channels and receiving channels, and processing the radar signals;
a transmitter comprising a plurality of transmitting antennas connected to the transmitting channels, respectively, and spaced apart from each other according to a predetermined transmitting antenna spacing factor and a unit separation distance; and
a receiver comprising a plurality of receiving antennas connected to the receiving channels, respectively, and spaced apart from each other according to a predetermined receiving antenna spacing factor and the unit separation distance,
wherein the transmitter comprises first to fourth transmitting antennas arranged sequentially, and
the receiver comprises first to fourth receiving antennas arranged sequentially, and
a total arrangement distance for the first to fourth transmitting antennas and a total arrangement distance for the first to fourth receiving antennas are set to be equal.

2. The radar apparatus of claim 1, wherein the predetermined transmitting antenna spacing factor comprises a first factor set between the first transmitting antenna and the second transmitting antenna, a second factor set between the second transmitting antenna and the third transmitting antenna, and a third factor set between the third transmitting antenna and the fourth transmitting antenna,
the predetermined receiving antenna spacing factor comprises a fourth factor set between the first receiving antenna and the second receiving antenna, a fifth factor set between the second receiving antenna and the third receiving antenna, and a sixth factor set between the third receiving antenna and the fourth receiving antenna, and
the first to sixth factors are set to different values.

3. The radar apparatus of claim 2, wherein a sum of the first to third factors is set equal to be a sum of the fourth to sixth factors.

4. The radar apparatus of claim 2, wherein if each of a sum of the first to third factors and a sum of the fourth to sixth factors is set to be 24, the second factor is set to be 12, and the fifth factor is set to be 19.

5. The radar apparatus of claim 4, wherein the first factor or the third factor is set to be one of 4 or 8, and
the fourth factor or the sixth factor is set to be one of 2 or 3.

6. The radar apparatus of claim 2, wherein if each of a sum of the first to third factors and a sum of the fourth to sixth factors is set to be 24, the second factor is set to be 19, and the fifth factor is set to be 12.

7. The radar apparatus of claim 6, wherein the first factor or the third factor is set to be one of 2 or 3, and
the fourth factor or the sixth factor is set to be one of 4 or 8.

8. The radar apparatus of claim 1, wherein the unit separation distance is set to be half a wavelength of a frequency of the radar signals.

9. The radar apparatus of claim 1, wherein the transmitting antennas are arranged on a straight line to be spaced apart from each other, and the receiving antennas are arranged on a straight line to be spaced apart from each other.

10. The radar apparatus of claim 9, wherein the straight line on which the transmitting antennas are arranged to be spaced apart from each other is parallel to the straight line on which the receiving antennas are arranged to be spaced apart from each other.

11. The radar apparatus of claim 1, wherein the transmitting antennas and the receiving antennas are arranged on a single straight line to be spaced apart from each other.

12. The radar apparatus of claim 1, wherein the signal processor creates 16 virtual channels and creates 48 difference co-arrays using the 16 virtual channels to process the radar signals, wherein one difference co-array having a non-uniform difference co-array spacing is removed from the 48 difference co-arrays and a uniform linear array is created using the 48 difference co-arrays to process the radar signals.

13. A radar apparatus comprising:
a signal processor controlling transmission and reception of radar signals through transmitting channels and receiving channels, and processing the radar signals;
a transmitter comprising a plurality of transmitting antennas connected to the transmitting channels, respectively, and spaced apart from each other according to a predetermined transmitting antenna spacing factor and a unit separation distance; and
a receiver comprising a plurality of receiving antennas connected to the receiving channels, respectively, and spaced apart from each other according to a predetermined receiving antenna spacing factor and the unit separation distance,
wherein the transmitter comprises first to fourth transmitting antennas arranged sequentially in a first direction, and
the receiver comprises first to fourth receiving antennas arranged sequentially in the first direction,
a total arrangement distance for the first to fourth transmitting antennas in the first direction and a total arrangement distance for the first to fourth receiving antennas in the first direction are set to be equal, and
at least one of the first to fourth transmitting antennas and the first to fourth receiving antennas is spaced apart in a second direction.

14. The radar apparatus of claim 13, wherein the predetermined transmitting antenna spacing factor comprises a first factor set between the first transmitting antenna and the second transmitting antenna, a second factor set between the second transmitting antenna and the third transmitting antenna, and a third factor set between the third transmitting antenna and the fourth transmitting antenna, and
the predetermined receiving antenna spacing factor comprises a fourth factor set between the first receiving antenna and the second receiving antenna, a fifth factor set between the second receiving antenna and the third receiving antenna, and a sixth factor set between the third receiving antenna and the fourth receiving antenna, and
the first to sixth factors are set to different values.

15. The radar apparatus of claim 13, wherein the first direction and the second direction are perpendicular to each other.

16. A vehicle control system comprising a radar apparatus, the vehicle control system comprising:
a radar apparatus controlling transmission and reception of radar signals through transmitting channels and receiving channels and processing the radar signals, wherein the radar apparatus comprises: a plurality of transmitting antennas connected to the transmitting channels, respectively, and spaced apart from each other according to a predetermined transmitting antenna spacing factor and a unit separation distance; a plurality of receiving antennas connected to the receiving channels, respectively, and spaced apart from each other according to a predetermined receiving antenna spacing factor and the unit separation distance, wherein the transmitter comprises first to fourth transmitting antennas arranged sequentially, the receiver comprises first to fourth receiving antennas arranged sequentially, and a total arrangement distance for the first to fourth transmitting antennas and a total arrangement distance for the first to fourth receiving antennas are set to be equal; and
a controller generating control signals based on vehicle's surrounding object information detected using the radar signals received from the radar apparatus.

17. The vehicle control system of claim 16, wherein the predetermined transmitting antenna spacing factor comprises a first factor set between the first transmitting antenna and the second transmitting antenna, a second factor set between the second transmitting antenna and the third transmitting antenna, and a third factor set between the third transmitting antenna and the fourth transmitting antenna,
the predetermined receiving antenna spacing factor comprises a fourth factor set between the first receiving antenna and the second receiving antenna, a fifth factor set between the second receiving antenna and the third receiving antenna, and a sixth factor set between the third receiving antenna and the fourth receiving antenna, and
the first to sixth factors are set to different values.

18. The vehicle control system of claim 16, wherein the unit separation distance is set to be half a wavelength of a frequency of the radar signals.

19. The vehicle control system of claim 16, wherein the transmitting antennas are arranged on a straight line to be spaced apart from each other, and the receiving antennas are arranged on a straight line to be spaced apart from each other.

20. The vehicle control system of claim 16, wherein the transmitting antennas and the receiving antennas are arranged on a single straight line to be spaced apart from each other.
